(19) United States
(12) Patent Application Publication
(10) Pub. No.: US 2008/0099082 A1
(43) Pub. Date: May 1, 2008

(54) GAS VALVE SHUTOFF SEAL

(75) Inventor: Patrick R. Moenkhaus, Mounds View, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/553,960

(22) Filed: Oct. 27, 2006

(51) Int. Cl. F16K 25/00

(52) U.S. Cl. 137/516.27

(57) ABSTRACT

A gas valve includes a valve body and a valve member disposed within the valve body. In one illustrative embodiment, the valve body includes a valve seat that has a lower seat portion and a side seat portion. In some cases, the valve member may include a shutoff disk and an elastomeric sealing bead disposed on the shutoff disk. The valve member may be axially movable between an open position, a just-closed position in which the elastomeric sealing bead contacts the lower seat portion, and an overtravel position in which the elastomeric sealing bead contacts and exerts a radial force on the side seat portion of the valve body.

### TECHNICAL FIELD

The present invention relates generally to valves such as gas valves.

### BACKGROUND

A number of gas-fed appliances are known. A gas-fed appliance typically employs a gas valve to control the flow of gas to a burner in which the gas is burned to produce heat. In many cases, a gas valve either permits gas to flow, or ceases to permit gas to flow in response to a control signal from a control device such as a thermostat or other controller. A need remains for improved gas valves.

### SUMMARY

The present invention relates generally to an improved gas valve. An illustrative but non-limiting example of the present invention may be found in a gas valve that includes a valve body, a valve member disposed within the valve body, and an elastomeric seal situated between the valve body and the valve member. The valve member may be movable between an open position in which gas flow is permitted through the gas valve and a closed position in which gas flow is not permitted through the gas valve. The gas valve may be configured so that when the gas valve is closed or closing, an axial force applied to the valve member is translated into a radial force at the elastomeric seal, and in response, the elastomeric seal may move in a radial direction. In some cases, the valve member may be configured to exhibit overtravel by moving the valve member beyond a just-closed position.

In some cases, the valve body may define a valve seat that includes a lower seat portion and a side seat portion. The valve member may include a shutoff disk, and in some cases, the elastomeric seal may be part of or disposed on the shutoff disk. When so provided, the valve member may be axially movable between an open position, an intermediate position in which the elastomeric seal contacts the lower seat portion, and an overtravel position in which the elastomeric seal contacts the side seat portion and exerts a radial force on the side seat portion of the valve body. In some instances, the elastomeric seal may not contact the side seat portion when the valve member is in the intermediate position. In some cases, the intermediate position may correspond to a just-closed position in which gas flow through the gas valve has just stopped.

Although not required, the elastomeric seal may include an elastomeric sealing bead that is part of or disposed about the shutoff disk. The elastomeric sealing bead may, if desired, extend axially and/or radially beyond the shutoff disk. In some cases, the elastomeric sealing bead may be cup or dished shaped. In some instances, the shutoff disk may include or be made from aluminum while the elastomeric sealing bead may include or be made from a rubber or any other suitable material. In some cases, the elastomeric sealing bead may be molded onto the shutoff disk.

In some cases, the elastomeric seal may be part of or disposed on the valve body, rather than on the valve member. When so provided, the valve member may include a first seat portion and a second side seat portion. The valve member may be axially movable between an open position, an intermediate position in which the elastomeric seal contacts the first seat portion of the valve member, and an over-travel position in which the elastomeric seal contacts the second side seat portion of the valve member and exerts a radial force on the second side seat portion.

The above summary of the present invention is not intended to describe each disclosed embodiment or every implementation of the present invention. The Figures, Detailed Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a partial cross-sectional view of a portion of a gas valve in accordance with an illustrative embodiment of the present invention;

FIG. 2 is a view of the illustrative gas valve of FIG. 1, showing the gas valve in a just-closed position;

FIG. 3 is a view of the illustrative gas valve of FIG. 1, showing the gas valve in a fully-closed position;

FIG. 4 is a partial cross-sectional view of a gas valve in accordance with an illustrative embodiment of the present invention;

FIG. 5 is a view of the illustrative gas valve of FIG. 4, showing the gas valve in a just-closed position;

FIG. 6 is a view of the illustrative gas valve of FIG. 4, showing the gas valve in a fully closed position;

FIG. 7 is a partial cross-sectional view of a gas valve in accordance with an illustrative embodiment of the present invention; and

FIG. 8 is a view of the illustrative gas valve of FIG. 7, showing the gas valve in a fully closed position.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

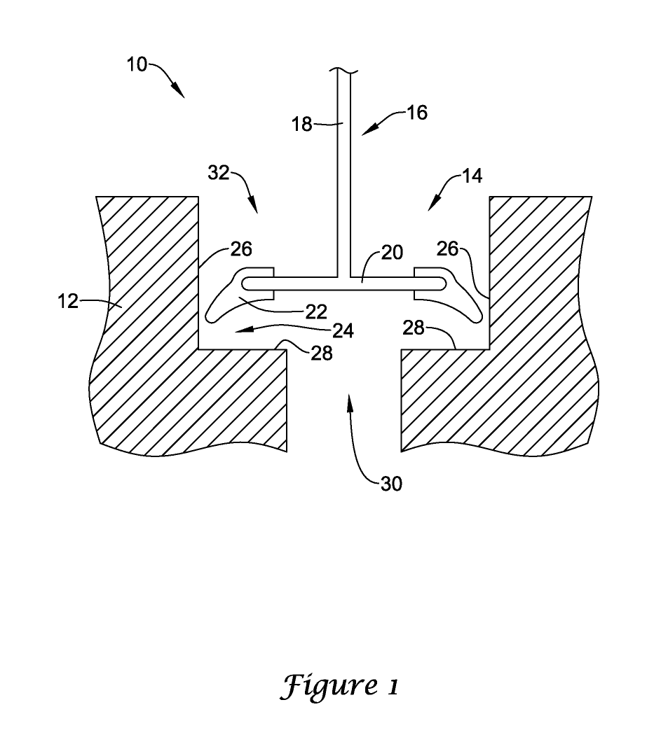

FIG. 1 is a partial cross-sectional view of a portion of an illustrative gas valve 10. Gas valve 10 includes a valve body 12 defining a valve cavity 14. Valve body 12 may be formed of any suitable material, using any suitable technique. In some instances, valve body 12 may be machined, cast or molded from any suitable metal, plastic, or any other material combination, as desired. A valve member 16 is shown movably disposed within valve cavity 14. Valve member 16 may be formed of any suitable material. In some cases, valve member 16 may be formed from any suitable material, such as metal, plastic, or any other material or material combination, as desired.

In some instances, valve member 16 may include a stem portion 18 and an enlarged-radius portion such as a shutoff disk 20. In some cases, stem portion 18 and shutoff disk 20 may be integrally formed, or separately formed and subsequently secured together, as desired. In the illustrative embodiment, an elastomeric sealing bead 22 may be part of, integrally formed with, or secured or otherwise disposed about shutoff disk 20. In some cases, stem portion 18 and/or shutoff disk 20 may include or otherwise be formed of a metal such as aluminum while elastomeric sealing bead 22 may include or otherwise be formed of rubber or an elastomeric polymer. In some instances, elastomeric sealing bead 22 may be molded onto shutoff disk 20.

Valve body 12 may define a valve seat 24 that may interact with valve member 16 to permit or, alternatively, to prevent gas flow through gas valve 10. Valve seat 24 may, if desired, be molded into valve body 12. In some cases, valve seat 24 may be formed via a material removal process such as grinding. In some instances, valve seat 24 may include a side seat portion 26 and a lower seat portion 28. In some cases, side seat portion 26 may be at least substantially perpendicular to lower seat portion 28, but this is not required in all embodiments. Side seat portion 26 may be at least substantially parallel to an axial travel direction of valve member 16, but again, this is not required in all embodiments.

Valve member 16 is movable between an open position in which gas flow is permitted through valve cavity 14 and a closed position in which gas does not flow through valve cavity 14. Valve member 16 may be moved in any suitable manner known in the art. For example, valve member 16 may move up and down (in the illustrated orientation) in response to a solenoid, an electric motor, a spring force, or any other appropriate movement mechanism, as desired. In this, upper and lower are relative terms pertaining to the illustrated embodiment. It will be recognized that gas valve 10 may function in any spatial orientation.

Valve cavity 14 may be considered as including a lower chamber 30 that is disposed below shutoff disk 20 and an upper chamber 32 that is disposed above shutoff disk 20. FIG. 1 shows gas valve 10 in an open position in which gas may, for example, enter valve cavity 14 through lower chamber 30, pass by shutoff disk 20, and exit valve cavity 14 through upper chamber 32. Alternatively, gas may enter valve cavity 14 through upper chamber 32 and may exit through lower chamber 30, depending on the configuration.

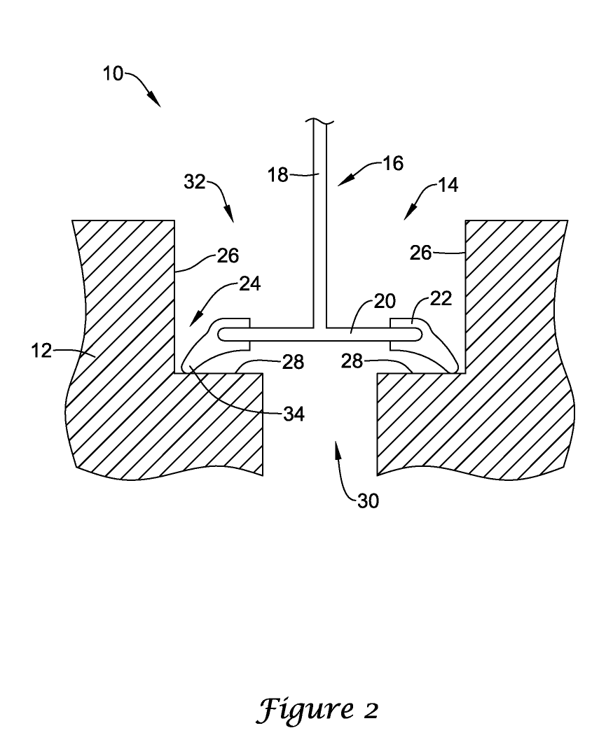

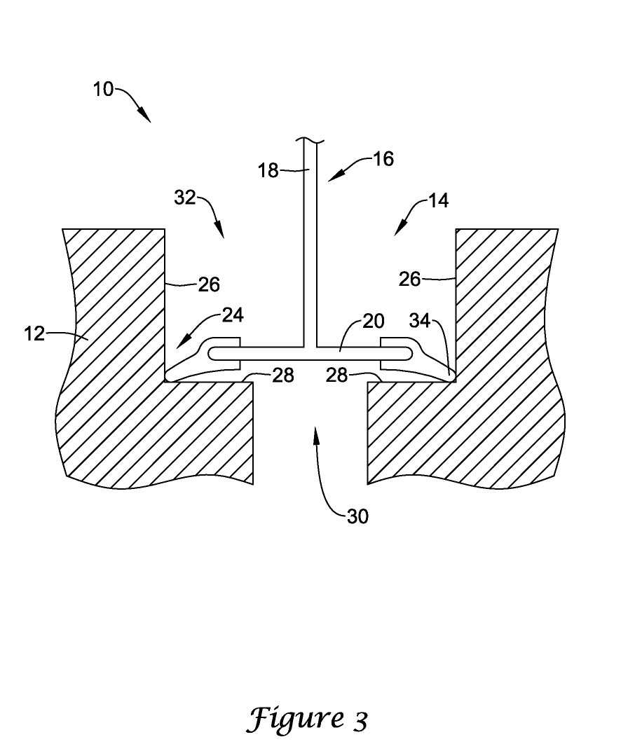

FIGS. 2 and 3 illustrate the closing of gas valve 10. In FIG. 2, valve member 16 has moved downwards to a position in which elastomeric sealing bead 22 has contacted valve seat 24. In some instances, elastomeric sealing bead 22 may include a sealing ring 34 that may be disposed at or near an outer periphery of elastomeric sealing bead 22. As shown in FIG. 2, elastomeric sealing ring 34 has now made contact with lower seat portion 28 but has not yet contacted or at least has not substantially contacted side seat portion 26. This position may be considered as an intermediate position, or as a just-closed position in which no gas flow or at least a substantially reduced gas flow is permitted past elastomeric sealing ring 34.

In FIG. 3, valve member 16 has moved further in a downward direction, and it can be seen that elastomeric sealing bead 22 has expanded radially such that sealing ring 34 has now made contact with side seat portion 26. As valve member 16 moves downward, sealing ring 34 is forced in a radially outward direction. In some instances, sealing ring 34 may provide a radial sealing force against side seat portion 26.

This position may be considered as an overtravel position. In some cases, the axial travel exhibited by valve member 16 in moving from the intermediate position, shown in FIG. 2, and the overtravel position, shown in FIG. 3, may be defined as overtravel. In some cases, overtravel may be useful in providing proof of closure. While not illustrated, shaft 18 of valve member 16 may extend to a switch that may be adapted to provide an electrical signal indicating overtravel. In some cases, this overtravel may be useful in overcoming manufacturing inaccuracies within valve body 12.

In some instances, elastomeric sealing bead 22 and/or sealing ring 34 may be considered as forming a first seal against lower seat portion 28 and a second seal against side seat portion 26 when valve member 16 is in the fully closed position. In some instances, elastomeric sealing bead 22 and/or sealing ring 34 may apply a radial force to side seat portion 26 that is greater in magnitude than an axial force applied to valve member 16 to move valve member 16 into the fully closed position. In some cases, an axial distance traveled by valve member 16 may be greater than a radial distance between sealing ring 34 and side seat portion 26 when elastomeric sealing bead 22 is in a relaxed configuration (not contacting side seat portion 26 or lower seat portion 28). Thus, the additional axial travel may act as a force multiplier.

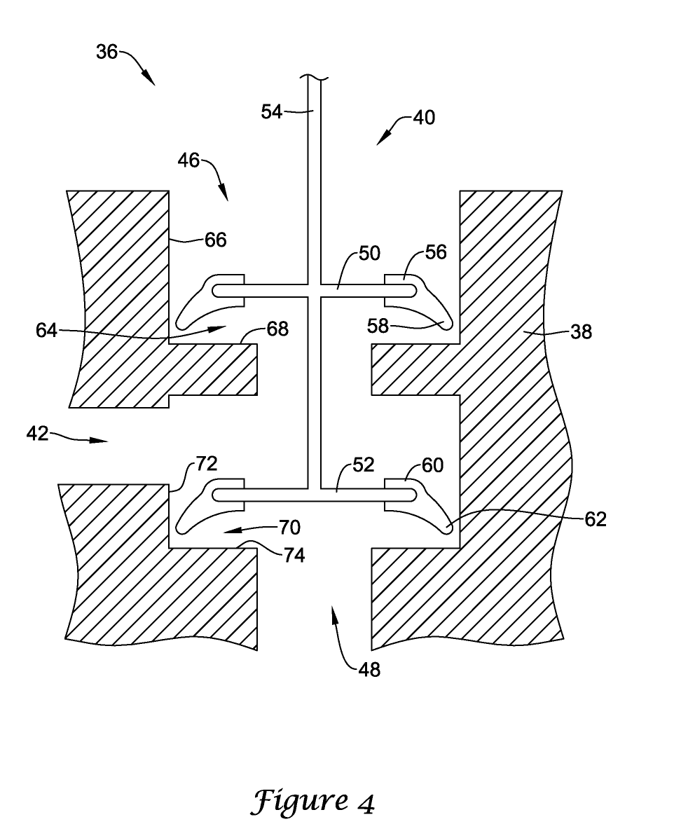

FIG. 4 is a schematic illustration of another illustrative gas valve 36. The illustrative gas valve 36 includes a valve body 38 defining a valve cavity 40. Valve body 38 may be formed of any suitable material, using any suitable technique. In some instances, valve body 38 may be machined, cast or molded from any suitable metal, plastic, or any other material combination, as desired. A valve member 42 is movably disposed within valve cavity 40. Valve member 42 may be formed of any suitable material. In some cases, valve member 42 may be formed from, for example, metal, plastic, or any other suitable material or material combination, as desired.

In some cases, valve cavity 40 may encompass several distinct regions within valve body 38. As illustrated, valve cavity 40 may include an inflow region 44, a first outflow region 46 and a second outflow region 48. In the illustrated configuration, it can be seen that gas may enter through inflow region 44 and may exit through first outflow region 46 and/or through second outflow region 48 when the valve is open.

In some instances, valve member 42 may include an upper shutoff disk 50 and a lower shutoff disk 52 that are either integrally formed with or secured to a stem 54. In the illustrative embodiment, an upper elastomeric sealing bead 56, sometimes including an upper sealing ring 58, is part of, integrally formed with, or disposed upon or otherwise secured to upper shutoff disk 50. Likewise, a lower elastomeric sealing bead 60, sometimes including a lower sealing ring 62, is part of, integrally formed with, or disposed upon or otherwise secured to lower shutoff disk 52. In some cases, valve member 42 may include or otherwise be formed of a metal such as aluminum while upper elastomeric sealing bead 56 and/or lower elastomeric sealing bead 60 may be formed of rubber and may, if desired, be molded onto upper shutoff disk 50 and/or lower shutoff disk 52, but this is not required.

Valve body 38 may define an upper valve seat 64 that may, as illustrated, include an upper side seat portion or wall 66 and an upper bottom seat portion 68. Valve body 38 may also define a lower valve seat 70 that may, as illustrated, include a lower side seat portion or wall 72 and a lower bottom seat portion 74. In some instances, the upper side seat portion 66 may be at least substantially perpendicular to upper bottom seat portion 68, but this is not required in all embodiments. Similarly, lower side seat portion 72 may be at least substantially perpendicular to lower bottom seat portion 74, but again, this is not required in all embodiments.

Valve member 42 may be movable between an open position in which gas flow is permitted through gas valve 36, and a closed position in which gas flow is not permitted through gas valve 36. Valve member 42 may be moved in any suitable manner known in the art. For example, valve member 42 may move up and down (in the illustrated orientation) in response to a solenoid, an electric motor, a spring force, or any other appropriate movement mechanism. In this, upper and lower are relative terms pertaining to the illustrated embodiment. It will be recognized that gas valve 36 may function in any spatial orientation.

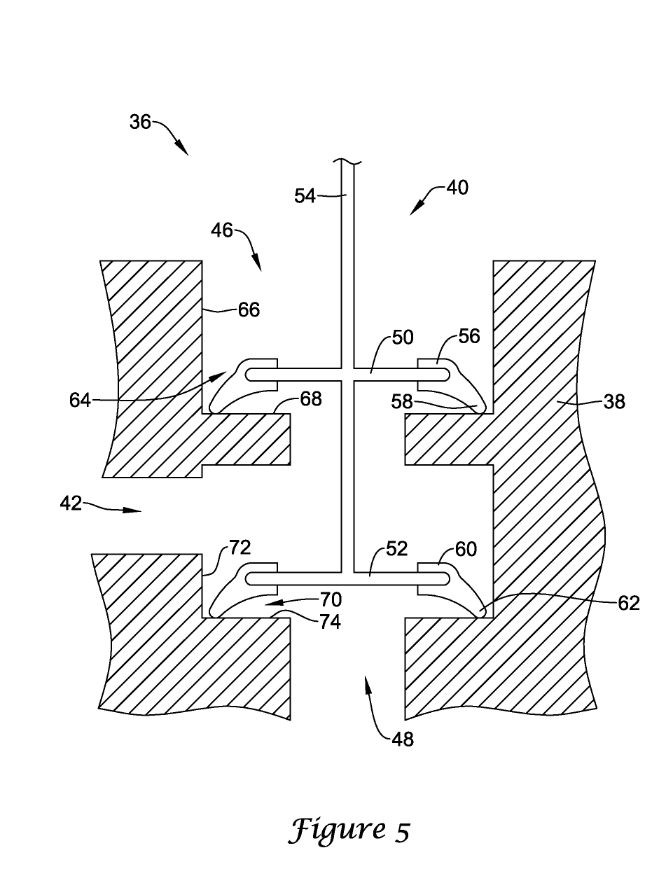

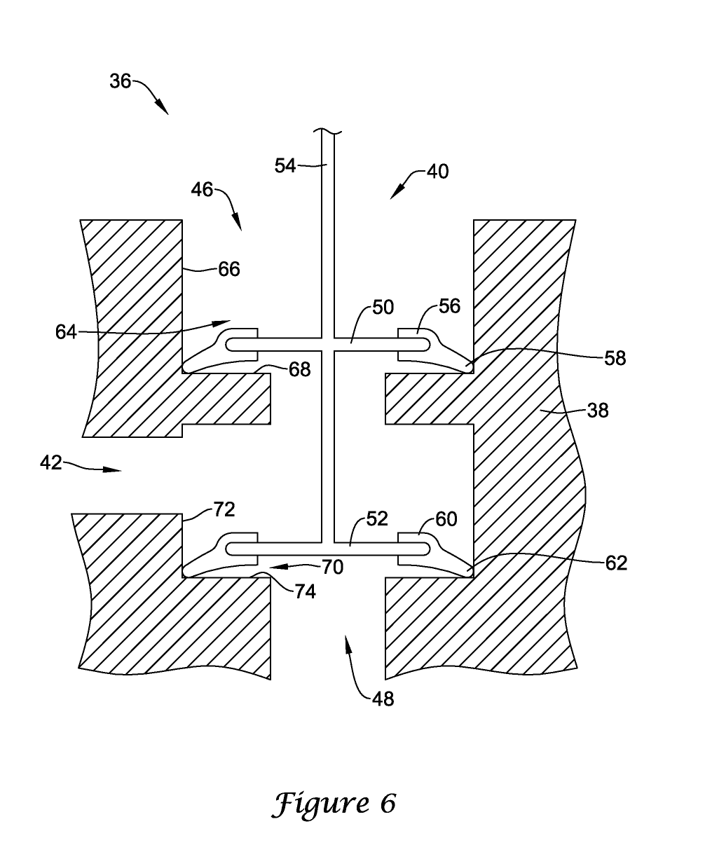

FIGS. 5 and 6 illustrate the closing of gas valve 36. In FIG. 5, valve member 42 has moved downwards to a position in which upper sealing ring 58 has made contact with upper bottom seat portion 68 but has not yet contacted or has not substantially contacted upper side seat portion 66. Likewise, lower sealing ring 62 has made contact with lower bottom seat portion 74 but has not yet contacted or has not substantially contacted lower side seat portion 72. This position may be considered as an intermediate position, or as a just-closed position in which no gas flow or at least a substantially reduced gas flow is permitted.

In FIG. 6, valve member 42 has moved further in a downward direction, and it can be seen that upper elastomeric sealing bead 56 has expanded radially such that upper sealing ring 58 has now made contact with upper side seat portion 66. In some instances, upper sealing ring 58 may apply a radial sealing force against upper side seat portion 66. Similarly, lower elastomeric sealing bead 60 has expanded radially such that lower sealing ring 62 has also made contact with lower side seat portion 72. In some instances, lower sealing ring 62 may apply a radial sealing force against lower side seat portion 72.

The position shown in FIG. 6 may be considered as an overtravel position. In some cases, the axial travel exhibited by valve member 42 in moving from the intermediate position, shown in FIG. 5, and the overtravel position, shown in FIG. 6, may be defined as overtravel. In some cases, overtravel may be useful in providing proof of closure and/or in overcoming manufacturing inaccuracies within valve body 38.

In some cases, gas valve 36 may be considered as being a balanced port valve in that gas entering inflow region 44 may flow past upper shutoff disk 50 and out through first outflow region 46 as well as past lower shutoff disk 52 and out through second outflow region 48. As gas flows past upper shutoff disk 50, the gas may exert an upward (as illustrated) force on valve member 42. Similarly, as gas flows past lower shutoff disk 52, the gas may exert a downward (as illustrated) force on valve member 42. These upwardly and downwardly applied forces may at least partially cancel each other out, meaning that a smaller net force is needed to move valve member 42 either up or down in order to either open or close gas valve 36.

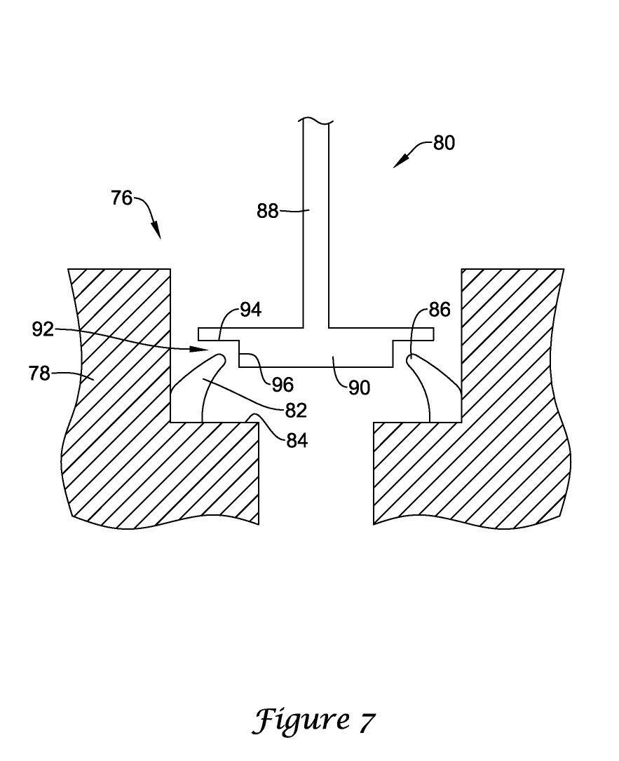

FIG. 7 is a schematic illustration of another illustrative gas valve 76. Illustrative gas valve 76 includes a valve body 78 and a valve member 80 disposed within valve body 78. Valve body 78 may be formed of any suitable material, using any suitable technique. In some instances, valve body 78 may be machined, cast or molded from any suitable metal, plastic, or any other material combination, as desired. Valve member 80 may be formed of any suitable material. In some cases, valve member 80 may be formed from, for example, metal, plastic, or any other suitable material or material combination, as desired.

An elastomeric sealing ring 82 is disposed within valve body 78. In some cases, elastomeric sealing ring 82 may be secured to or otherwise disposed on a sealing ring support 84 that is molded or otherwise formed within valve body 78. Elastomeric sealing ring 82 may include a sealing ring 86 and may be formed of any suitable material. In some cases, elastomeric sealing ring 82 may include or be formed of rubber.

Valve member 80 includes a stem 88 and a shutoff disk 90. Shutoff disk 90 includes a valve seat 92 that may include an upper seat portion 94 and a side seat portion 96. In some cases, shutoff disk 90 includes or is formed of a metal such as aluminum. Valve member 80 may be movable between an open position in which gas flow is permitted through gas valve 76, and a closed position in which gas flow is not permitted through gas valve 76. Valve member 80 may be moved in any suitable manner known in the art. For example, valve member 80 may move up and down (in the illustrated orientation) in response to a solenoid, an electric motor, a spring force, or any other appropriate movement mechanism.

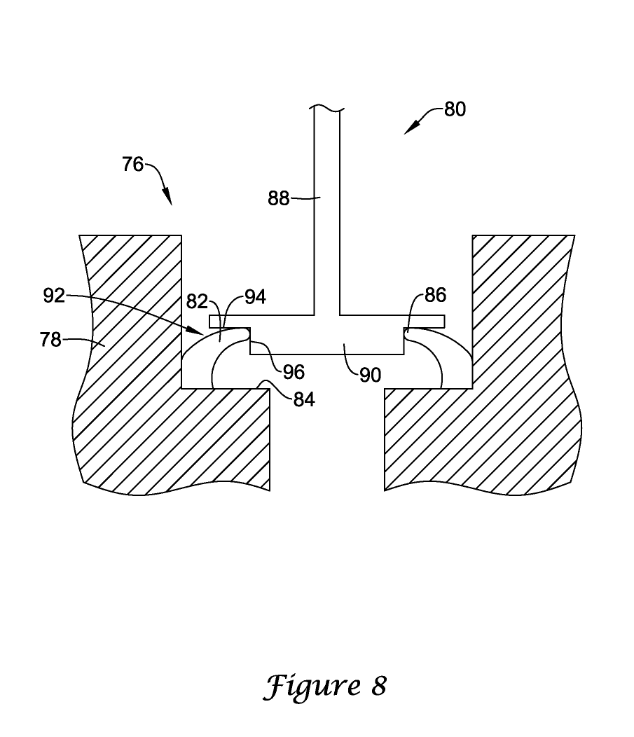

In FIG. 7, valve member 80 is shown in an open position in which gas may flow through gas valve 76. FIG. 8 illustrates valve member 80 in a fully closed position. By comparing FIGS. 7 and 8, it will be appreciated that valve member 80 has a just-closed or intermediate position in which sealing ring 86 contacts upper seat portion 94 but does not contact or at least does not substantially contact side seat portion 96. In FIG. 8, sealing ring 86 has, in response to axial movement of valve member 80, contracted radially and has contacted side seat portion 96. In some cases, sealing ring 86 may apply a sealing radial force to side seat portion 96.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

We claim:

1. A gas valve comprising:
a valve body;
a valve member disposed within the valve body; and
an elastomeric sealing bead situated between the valve body and the valve member;
wherein, when the gas valve is closed, an axial force that is applied to the valve member translates into a radial force at the elastomeric sealing bead.

2. The gas valve of claim 1, wherein the valve member is movable between an open position in which gas flow is permitted through the gas valve and a closed position in which gas flow is not permitted through the gas valve.

3. The gas valve of claim 2, wherein the elastomeric sealing bead expands radially in response to the valve member moving axially from the open position to the closed position under the radial force.

4. The gas valve of claim 1, wherein the radial force has a magnitude that is greater than the axial force applied to the valve member.

5. The gas valve of claim 2, wherein the valve member is configured to move beyond a just-closed position, thereby exhibiting overtravel.

6. A gas valve comprising:
a valve body defining a valve seat, the valve seat having a lower seat portion and a side seat portion; and
a valve member disposed within the valve body, the valve member comprising a shutoff disk and an elastomeric sealing bead secured relative to the shutoff disk;
wherein the valve member is axially movable between an open position, a just-closed position in which the elastomeric sealing bead contacts the lower seat portion, and an overtravel position in which the elastomeric sealing bead contacts and exerts a radial force on the side seat portion.

7. The gas valve of claim 6, wherein the elastomeric sealing bead does not substantially contact the side seat portion when the valve member is in the just-closed position.

8. The gas valve of claim 6, wherein the just-closed position corresponds to a position in which gas flow through the gas valve is initially stopped.

9. The gas valve of claim 6, wherein the overtravel position corresponds to a closed position in which the valve member exhibits overtravel.

10. The gas valve of claim 6, wherein the lower seat portion is substantially perpendicular to a direction of axial movement of the valve member.

11. The gas valve of claim 10, wherein the side seat portion is substantially parallel to the direction of axial movement of the valve member.

12. The gas valve of claim 6, wherein the elastomeric sealing bead is disposed about the shutoff disk.

13. The gas valve of claim 12, wherein the elastomeric sealing bead extends axially beyond the shutoff disk.

14. The gas valve of claim 12, wherein the elastomeric sealing bead extends radially from the shutoff disk.

15. The gas valve of claim 12, wherein the shutoff disk comprises aluminum and the elastomeric sealing bead comprises rubber.

16. The gas valve of claim 15, wherein the elastomeric sealing bead is molded onto the shutoff disk.

17. The gas valve of claim 6, wherein the elastomeric sealing bead is configured to provide a first seal against the lower seat portion and a second seal against the side seat portion.

18. A dual gas valve comprising:
a valve chamber comprising an upper valve seat and a lower valve seat;
a valve member disposed within the valve body, the valve member movable between an open position in which gas flow is permitted through the dual gas valve and a closed position in which gas flow is not permitted through the dual gas valve, the valve member comprising an upper shutoff disk and a lower shutoff disk;
an upper elastomeric sealing bead secured relative to the upper shutoff disk and a lower elastomeric sealing bead secured relative to the lower shutoff disk
wherein moving the valve member from the open position to the closed position forces the upper elastomeric sealing bead to expand radially against the upper valve seat and forces the lower elastomeric sealing bead to expand radially against the lower valve seat.

19. The dual gas valve of claim 18, wherein the valve chamber includes an upper seat side portion and a lower seat side portion, wherein moving the valve member beyond an intermediate just-closed position forces the upper elastomeric sealing bead to expand radially against the upper seat side portion and forces the lower elastomeric sealing bead to expand radially against the lower seat side portion.

20. The dual gas valve of claim 18, wherein the valve member moves axially between the open position and the closed position.
